(19) United States
(12) Patent Application Publication
(10) Pub. No.: US 2020/0129864 A1
(43) Pub. Date: Apr. 30, 2020

(54) DETECTING AND IDENTIFYING IMPROPER ONLINE GAME USAGE

(71) Applicant: International Business Machines Corporation, Armonk, NY (US)

(72) Inventors: Richard V. Tran, San Jose, CA (US); Kevin D. Hite, Morgan Hill, CA (US)

(21) Appl. No.: 16/176,304

(22) Filed: Oct. 31, 2018

(51) Int. Cl. A63F 13/75; A63F 13/35; A63F 13/79

(52) U.S. Cl. CPC A63F 13/75; A63F 13/35; A63F 2300/5546; A63F 2300/535; A63F 2300/5586; A63F 13/79

(57) ABSTRACT

Methods, systems, and computer products for identifying improper online game usage are provided. Aspects include receiving, by a processor, online gaming data associated with an online gaming environment, the online gaming environment having a plurality of users, analyzing the online gaming data to identify a user from the plurality of users improperly interacting with the online gaming environment, accessing a user profile for the user responsive to identifying the user, determining a rating for the improper interaction of the user based on the online gaming data and the user profile, comparing the rating for the improper interaction of the user to one or more threshold ratings, and enacting a penalty for the user based at least in part the rating of the improper interaction exceeding at least one of the one or more threshold ratings.

### BACKGROUND

The present invention generally relates to online gaming systems, and more specifically, to detecting and identifying improper online game usage.

A griefer or bad faith player is a player in a multiplayer video game, typically online and anonymous, who deliberately irritates and harasses other players within the game, using aspects of the game in unintended ways. These aspects of the game can include exploiting in-game bugs, such as, for example travelling out of bounds of a map in the online game environment. Other aspects can include actions undertaken to waste other online player's time by interacting slowly with other players in a turn-based game in an effort to slow down normal game play. A griefer, typically, derives satisfaction primarily or exclusively from the act of annoying other users in online gaming, and as such is a particular nuisance in online gaming communities, since griefers often cannot be deterred by penalties related to in-game goals. As griefers are not technically cheating in the online and/or multiplayer games, it can be difficult from a system standpoint to identify and confirm that a player is griefing.

### SUMMARY

Embodiments of the present invention are directed to a computer-implemented method for identifying improper game usage. A non-limiting example of the computer-implemented method includes receiving, by a processor, online gaming data associated with an online gaming environment, the online gaming environment having a plurality of users, analyzing the online gaming data to identify a user from the plurality of users improperly interacting with the online gaming environment, accessing a user profile for the user responsive to identifying the user, determining a rating for the improper interaction of the user based on the online gaming data and the user profile, comparing the rating for the improper interaction of the user to one or more threshold ratings, and enacting a penalty for the user based at least in part the rating of the improper interaction exceeding at least one of the one or more threshold ratings.

Embodiments of the present invention are directed to a system for identifying improper game usage. A non-limiting example of the system includes a processor communicatively coupled to a memory, the processor configured to perform receiving online gaming data associated with an online gaming environment, the online gaming environment having a plurality of users, analyzing the online gaming data to identify a user from the plurality of users improperly interacting with the online gaming environment, accessing a user profile for the user responsive to identifying the user, determining a rating for the improper interaction of the user based on the online gaming data and the user profile, comparing the rating for the improper interaction of the user to one or more threshold ratings, and enacting a penalty for the user based at least in part the rating of the improper interaction exceeding at least one of the one or more threshold ratings.

Embodiments of the invention are directed to a computer program product for identifying improper game usage, the computer program product comprising a computer readable storage medium having program instructions embodied therewith. The program instructions are executable by a processor to cause the processor to perform a method. A non-limiting example of the method includes receiving, by a processor, online gaming data associated with an online gaming environment, the online gaming environment having a plurality of users, analyzing the online gaming data to identify a user from the plurality of users improperly interacting with the online gaming environment, accessing a user profile for the user responsive to identifying the user, determining a rating for the improper interaction of the user based on the online gaming data and the user profile, comparing the rating for the improper interaction of the user to one or more threshold ratings, and enacting a penalty for the user based at least in part the rating of the improper interaction exceeding at least one of the one or more threshold ratings.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts a block diagram of a computer system for use in implementing one or more embodiments of the present invention;

FIG. 4 depicts a block diagram of a system for detecting and identifying improper online game usage according to one or more embodiments of the invention; and

FIG. 5 depicts a flow diagram of a method for identifying improper online game usage according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

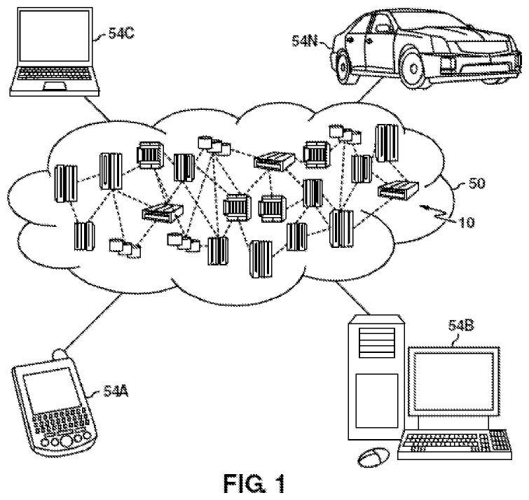

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

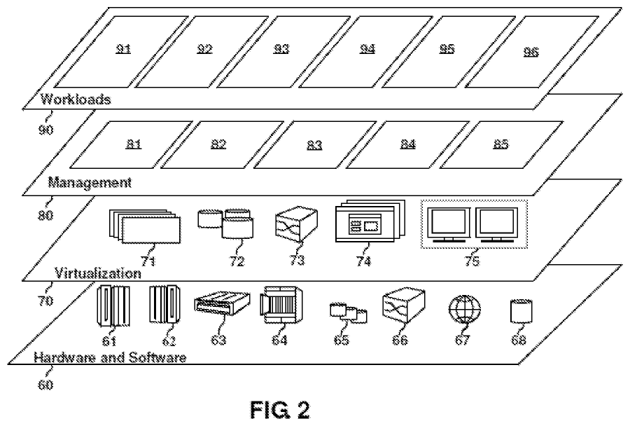

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and identifying and confirming improper online game usage 96.

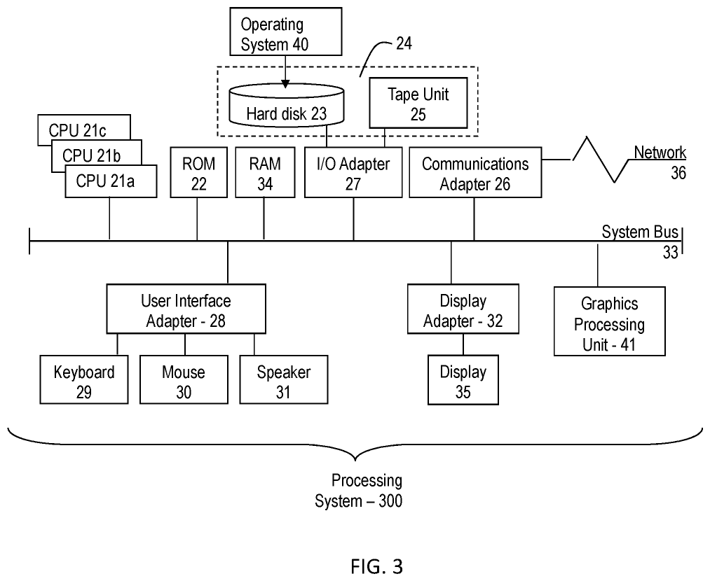

Referring to FIG. 3, there is shown an embodiment of a processing system 300 for implementing the teachings herein. In this embodiment, the system 300 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 300.

FIG. 3 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 300 may be stored in mass storage 24. A network adapter 26 interconnects bus 33 with an outside network 36 enabling data processing system 300 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 300 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 3, the system 300 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 3.

Turning now to an overview of technologies that are more specifically relevant to aspects of the invention, as mentioned above, griefing can detract from the satisfaction and enjoyment of online games. Online game environments can often times include hundreds, if not, thousands of users. An example of these large scale online game environments includes massively multiplayer online role-playing games (MMORPG). MMORPGs can include large scale maps with hundreds of players interacting to perform aspects of the game such as completion of quests and even fight battles between different groups of players. The online community (e.g., users) often interact with each other either through text messaging or vocal interactions in group or individual chatting functions built into the online game. These online games are played using computing platforms such as personal computers or video game consoles. The online community can include registered users, anonymous (or guest) users, or a combination of both. Because of the inherent anonymity of the users in these online games, users can become emboldened to grief other online players. Given the scale of these online communities, there can be difficulty in identifying and confirming that a user is griefing and to what extent are they griefing.

Turning now to an overview of the aspects of the invention, one or more embodiments of the invention address the above-described shortcomings of the prior art by providing a system for identifying griefers or bad-faith users in an online gaming environment utilizing machine learning techniques. In embodiments of the invention, game recording data can be analyzed to train a machine learning model for the identification of griefers or bad-faith users of a video game. This game recording data can be taken from recordings of game play by other users and identified as proper game play by “experts” in the online game. The expert online gamers can be determined based on the expert's status among members of the online community. In other embodiments, the experts can be determined based on their popularity on video sharing sites that display their online game play.

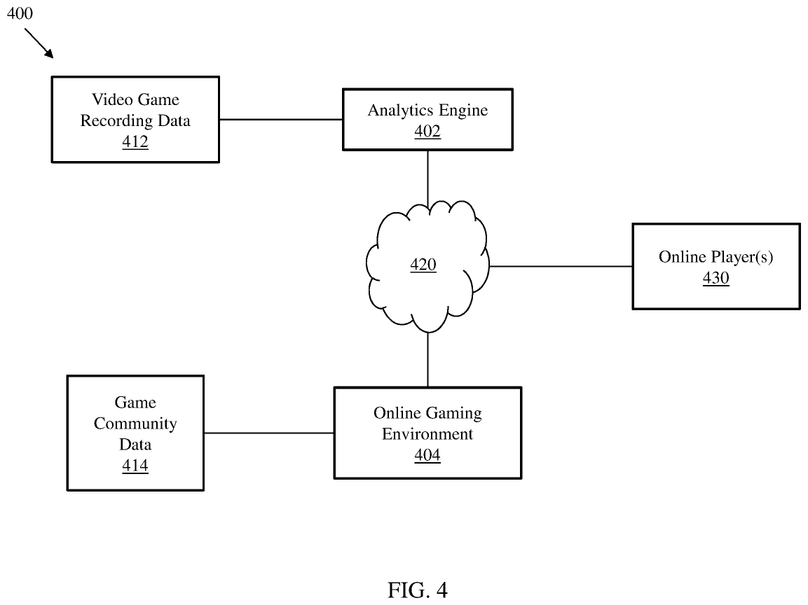

Turning now to a more detailed description of aspects of the present invention, FIG. 4 depicts a system for detecting and identifying improper online game usage according to embodiments of the invention. The system 400 includes an analytics engine 402 and an online gaming environment 404. The online gaming environment 404 can be operated on one or more servers accessible by players (users) through a network 420 connection. Game community data 414 can be stored on a database on the one or more servers that includes player data. The player data can include a player profile for each player as well as historical data about the player's interactions with the online gaming environment. The player profile can be utilized to identify individual players through the use of avatars, user names, real names, or other identifying information about the player such as payment or registration data for access to the online gaming environment 404.

In embodiments of the invention, the analytics engine 402 can also be implemented as so-called classifiers (described in more detail below). In one or more embodiments of the invention, the features of the various engines/classifiers (402) described herein can be implemented on the processing system 300 shown in FIG. 3, or can be implemented on a neural network (not shown). In embodiments of the invention, the features of the engines/classifiers 402 can be implemented by configuring and arranging the processing system 300 to execute machine learning (ML) algorithms. In general, ML algorithms, in effect, extract features from received data (e.g., inputs to the engines 402) in order to “classify” the received data. Examples of suitable classifiers include but are not limited to neural networks (described in greater detail below), support vector machines (SVMs), logistic regression, decision trees, hidden Markov Models (HMMs), etc. The end result of the classifier's operations, i.e., the “classification,” is to predict a class for the data. The ML algorithms apply machine learning techniques to the received data in order to, over time, create/train/update a unique “model.” The learning or training performed by the engines/classifiers 402 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In embodiments of the invention where the engines/classifiers 402 are implemented as neural networks, a resistive switching device (RSD) can be used as a connection (synapse) between a pre-neuron and a post-neuron, thus representing the connection weight in the form of device resistance. Neuromorphic systems are interconnected processor elements that act as simulated “neurons” and exchange “messages” between each other in the form of electronic signals. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. For example, a neuromorphic/neural network for handwriting recognition is defined by a set of input neurons, which can be activated by the pixels of an input image. After being weighted and transformed by a function determined by the network's designer, the activations of these input neurons are then passed to other downstream neurons, which are often referred to as “hidden” neurons. This process is repeated until an output neuron is activated. Thus, the activated output neuron determines (or “learns”) which character was read. Multiple pre-neurons and post-neurons can be connected through an array of RSD, which naturally expresses a fully-connected neural network. In the descriptions here, any functionality ascribed to the system 400 can be implemented using the processing system 300 applies.

In one or more embodiments of the invention, the cloud computing system 50 can be in wired or wireless electronic communication with one or all of the elements of the system 400. Cloud 50 can supplement, support or replace some or all of the functionality of the elements of the system 400. Additionally, some or all of the functionality of the elements of system 400 can be implemented as a node 10 (shown in FIGS. 1 and 2) of cloud 50. Cloud computing node 10 is only one example of a suitable cloud computing node and is not intended to suggest any limitation as to the scope of use or functionality of embodiments of the invention described herein.

In one or more embodiments, the analytics engine 402 can utilize one or more machine learning models. These machine learning models can be trained or tuned utilizing so-called labeled training data. This labeled training data can be taken from the video game recording data 412. The video game recording data can be videos shared by “expert” players or players that are considered trusted. These expert players typically play the video game or interact in the online gaming environment according to rules and customs established in the online gaming environment 404. The expert or trusted players can be established by other players in the online gaming environment or can be established by the analytics engine 402 based on no instances or few instances of improper play in the online gaming environment 404.

In one or more embodiments, the analytics engine 402 can identify players in the online gaming environment 404 that are improperly interacting with the online gaming environment 404. The system 400 includes online players 430 that access the online gaming environment 404 through a network 420 connection. The online players 430 typically register themselves in the online gaming environment 404 through a registration process or through a payment process, if the game is a paid access game. The registration process results in a stored player profile for each player and is stored in the game community data 414. The player profile can store data about the identity of the players as well as technical data regarding the player's access to the online gaming environment. The technical data can include information such as, for example, internet protocol (IP) address, game console type, software version history for accessing the game, and the like.

In one or more embodiments of the invention, the analytics engine 402 can analyze game play data in the online gaming environment 404 and determine an online player 430 that is griefing other players. As mentioned above, griefing involves the intentional interactions with other players that cause grief to the other players. Examples include exploiting bugs within the game to gain an unfair advantage over other players, intentionally delaying or drawing out game play for the other players, and using inappropriate language with other players. The analytics engine 402 can analyze a combination of video, audio, and textual data to identify and confirm that an online player is griefing or is improperly interacting with the online gaming environment 404. As described above, machine learning techniques are utilized by the analytics engine 402 to determine, based on the game play data (e.g., video, audio, and text), that a player is improperly interacting with the online gaming environment. For example, the analytics engine 402 can extract features from the online gaming data to build a feature vector. The feature vector can be analyzed by machine learning techniques to identify and determine players that are improperly interacting with the online gaming environment 404. The level of improper interaction can be compared to one or more thresholds to determine a penalty to enact against the player. The level of improper interaction can be determined by a variety of machine learning techniques. Also, the level of improper interaction can be determined by other players in the online gaming environment 404 or by a game administrator. For example, if a player is suspected of griefing, a description of the griefing can be generated and presented to other players or player “experts” in the online gaming environment. The other players can rate the griefing (e.g., high, medium, low and the like) and also vote on or recommend certain types of penalties. Penalties can range from a complete ban from the online gaming environment 404 to a warning or temporary ban. Other penalties can include, but are not limited to, limiting access to the online gaming environment 404, limiting certain features available to the player in the online gaming environment 404, throttling the player's internet access to the online gaming environment 404, and the like. More severe penalties can include banning of the user completely from the gaming platform and not just a specific game. For example, a large entertainment company that runs multiple games could ban a user from every game they operate instead of just the one the user is utilizing improperly (e.g., griefing).

The analytics engine 402 analyzes, using a machine learning model, the input (e.g., speech, text, video data, etc.) using sentiment, tonal analysis to identify potential users that are causing online griefing. The analytics engine 402 can perform natural language processing (NLP) analysis techniques on audio data taken from the online gaming environment 404 during interactions between the many players. NLP is utilized to derive meaning from natural language. A speech to text (STT) module can translate the audio data to text for processing by the analytics engine 402. The analytics engine 402 can analyze the presentation audio by parsing, syntactical analysis, morphological analysis, and other processes including statistical modeling and statistical analysis. The type of NLP analysis can vary by language and other considerations. The NLP analysis is utilized to generate a first set of NLP structures and/or features which can be utilized by a computer to identify and generate certain keywords indicative of a mood or sentiment of the presentation. These NLP structures include a translation and/or interpretation of the natural language input, including synonymous variants thereof.

A sentiment analysis module and a tonal analysis module can be utilized by the analytics engine 402 to determine a sentiment from the audio/textual data. In one or more embodiments, the online gaming environment 404 can include a text messaging module to allow players to communicate via text with each other. Any cognitive AI can be utilized within the sentiment analysis module. The sentiment analysis module can process natural language to incorporate both a linguistic and statistical analysis in evaluating the context of a communication. In text analysis, the sentiment is the attitude or opinion expressed toward something. Sentiment can be positive, “sounds good”, negative, “this is bad”, or neutral. Sentiment can be calculated based on keywords extracted and evaluated at a keyword level. Additionally, the sentiment analysis may be capable of identifying negations, such as the term “not” and the change in sentiment from the keyword “good” when the phrase is “not” “good”. The sentiment analysis may consider intensity when the terms “very” or other adjectives are utilized in combination with a keyword. Additionally, the keywords may be weighted. For instance, a positive phrase such as “like” will have a predefined positive weight, whereas the phrase “love” might have a higher predefined positive weight. Additionally, negative weights may be afforded negative phrases such as “dislike” would have a predefined negative weight and the phrase “hate” might have a higher negative weight. The sentiment analysis module can evaluate the content to provide a sentiment level. This sentiment level may also include an intensity value. A tonal analysis module can use linguistic analysis to detect three types of tones from the text. The natural language content is analyzed by the tonal analysis module for determining the emotional impact, social tone, and writing style that the content projects. The tonal analysis module may provide tonal scores for emotional tone, social tone, and language tone. For emotional tone, the tonal analysis module may utilize the emotions for “joy”, “fear”, “sadness”, “disgust” and “anger”. Each natural language element is evaluated with respect to each emotion. Each emotion may be evaluated from lower values having a value range that indicates if that emotion is less likely to appear as perceived or alternatively to a higher value range if the emotion is more likely to be perceived with respect to each natural language content. Other emotions may be utilized as well as a different value score.

In one or more embodiments, audio and text data can be analyzed by the analytics engine 402 to identify and detect griefing. In addition, certain keywords can be analyzed to trigger an analysis such as jargon terms associated with the online gaming environment 404. In first-person combat games, terms like “camping,” “friendly fire,” “spamming,” and “smurfing” can be added to a jargon lexicon to assist with identifying potential griefers. The keywords can be extracted from the audio data or from message boards or instant messaging. For example, if a group of players repeatedly refer to another specific player with certain keywords, the analytics engine 402 can identify the griefing player based on these keywords. New jargon terms and memes can get added quickly and can vary depending on locale.

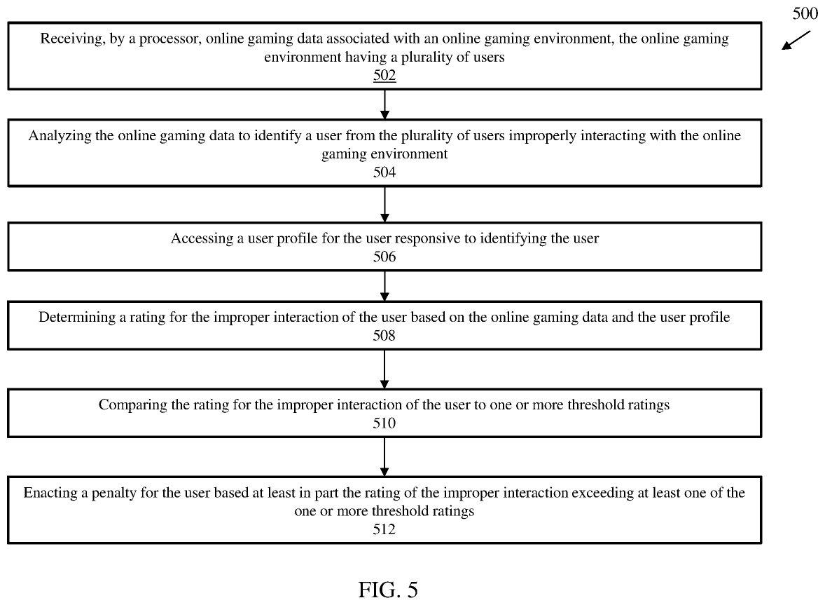

FIG. 5 depicts a flow diagram of a method for identifying improper online game usage according to one or more embodiments of the invention. The method 500 includes receiving, by a processor, online gaming data associated with an online gaming environment, the online gaming environment having a plurality of users, as shown at block 502. And at block 504, the method 500 includes analyzing the online gaming data to identify a user from the plurality of users improperly interacting with the online gaming environment. At block 506, the method 500 includes accessing a user profile for the user responsive to identifying the user. The method 500, at block 508, includes determining a rating for the improper interaction of the user based on the online gaming data and the user profile. Also, the method 500 includes comparing the rating for the improper interaction of the user to one or more threshold ratings, as shown at block 510. And at block 512, the method 500 includes enacting a penalty for the user based at least in part the rating of the improper interaction exceeding at least one of the one or more threshold ratings.

Additional processes may also be included. It should be understood that the processes depicted in FIG. 5 represent illustrations, and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for identifying improper online game usage, the method comprising:
receiving, by a processor, online gaming data associated with an online gaming environment, the online gaming environment having a plurality of users;
analyzing the online gaming data to identify a user from the plurality of users improperly interacting with the online gaming environment;
accessing a user profile for the user responsive to identifying the user;
determining a rating for the improper interaction of the user based on the online gaming data and the user profile;
comparing the rating for the improper interaction of the user to one or more threshold ratings;
enacting a penalty for the user based at least in part the rating of the improper interaction exceeding at least one of the one or more threshold ratings.

2. The computer-implemented method of claim 1, wherein identifying the user from the plurality of users improperly interacting with the online gaming environment comprises analyzing a feature vector, generated by a machine learning model, the feature vector comprising a plurality of features extracted from the online gaming data.

3. The computer-implemented method of claim 2, wherein the machine learning model is trained using recorded game play associated with the online gaming environment.

4. The computer-implemented method of claim 1, wherein the penalty comprises a ban from interacting with the online gaming environment.

5. The computer-implemented method of claim 1, wherein the penalty comprises presenting the improper interaction of the user to the plurality of users for voting for an action to be taken against the user.

6. The computer-implemented method of claim 1, wherein the user profile comprises historical user data associated with the online gaming environment.

7. The computer-implemented method of claim 1, wherein the online gaming data comprises video data, textual data, and audio data associated with the online gaming environment.

8. A computer program product for identifying improper online game usage, the computer program product comprising a computer readable storage medium having program instructions embodied therewith, wherein the computer readable storage medium is not a transitory signal per se, the program instructions executable by a processor to cause the processor to perform a method comprising:
receiving, by the processor, online gaming data associated with an online gaming environment, the online gaming environment having a plurality of users;
analyzing the online gaming data to identify a user from the plurality of users improperly interacting with the online gaming environment;
accessing a user profile for the user responsive to identifying the user;
determining a rating for the improper interaction of the user based on the online gaming data and the user profile;
comparing the rating for the improper interaction of the user to one or more threshold ratings;
enacting a penalty for the user based at least in part the rating of the improper interaction exceeding at least one of the one or more threshold ratings.

9. The computer program product of claim 8, wherein identifying the user from the plurality of users improperly interacting with the online gaming environment comprises analyzing a feature vector, generated by a machine learning model, the feature vector comprising a plurality of features extracted from the online gaming data.

10. The computer program product of claim 9, wherein the machine learning model is trained using recorded game play associated with the online gaming environment.

11. The computer program product of claim 8, wherein the penalty comprises a ban from interacting with the online gaming environment.

12. The computer program product of claim 8, wherein the penalty comprises presenting the improper interaction of the user to the plurality of users for voting for an action to be taken against the user.

13. The computer program product of claim 8, wherein the user profile comprises historical user data associated with the online gaming environment.

14. The computer program product of claim 8, wherein the online gaming data comprises video data, textual data, and audio data associated with the online gaming environment.

15. A system for identifying improper online game usage, the system comprising:
a processor communicatively coupled to a memory, the processor configured to:
receive online gaming data associated with an online gaming environment, the online gaming environment having a plurality of users;
analyze the online gaming data to identify a user from the plurality of users improperly interacting with the online gaming environment;
access a user profile for the user responsive to identifying the user;
determine a rating for the improper interaction of the user based on the online gaming data and the user profile;
compare the rating for the improper interaction of the user to one or more threshold ratings;
enact a penalty for the user based at least in part the rating of the improper interaction exceeding at least one of the one or more threshold ratings.

16. The system of claim 15, wherein identifying the user from the plurality of users improperly interacting with the online gaming environment comprises analyzing a feature vector, generated by a machine learning model, the feature vector comprising a plurality of features extracted from the online gaming data.

17. The system of claim 16, wherein the machine learning model is trained using recorded game play associated with the online gaming environment.

18. The system of claim 15, wherein the penalty comprises a ban from interacting with the online gaming environment.

19. The system of claim 15, wherein the penalty comprises presenting the improper interaction of the user to the plurality of users for voting for an action to be taken against the user.

20. The system of claim 15, wherein the user profile comprises historical user data associated with the online gaming environment.
